(19) United States
(12) Patent Application Publication
(10) Pub. No.: US 2011/0014423 A1
(43) Pub. Date: Jan. 20, 2011

(54) CERAMIC POWDER COMPOSITIONS AND OPTOELECTRONIC DEVICE SUBSTRATES UTILIZING THE SAME

(76) Inventors: Yu-Hsin YEH, Taipei County (TW); Jiin-Jyh Shyu, Taipei County (TW); Ren-Der Jean, Hsinchu City (TW); Tzer-Shen Lin, Hsinchu City (TW)

Correspondence Address: BIRCH STEWART KOLASCH & BIRCH, PO BOX 747, FALLS CHURCH, VA, 22040-0747, US

(21) Appl. No.: 12/650,927

(22) Filed: Dec. 31, 2009

(30) Foreign Application Priority Data
Jul. 14, 2009 (TW) 98123688

(51) Int. Cl. B32B 3/00; C04B 35/10; C04B 35/14; C03C 14/00; C03C 10/14; C03C 10/02; B32B 18/00

(52) U.S. Cl. 428/141; 501/153; 501/154; 501/32; 501/4; 501/10; 428/426; 428/446

(57) ABSTRACT

A ceramic powder composition and an optoelectronic device substrate utilizing the ceramic powder composition are disclosed. The optoelectronic device substrate is formed by sintering a ceramic powder composition including 4 to 97 wt % (weight percent) of zircon, 0 to 60 wt % of silicon dioxide, and 0 to 80 wt % of alumina, wherein the sintered ceramic substrate includes first and second crystalline phases, the first crystalline phase is zircon, and the second crystalline phase is at least one of or a combination of alumina, silicon dioxide, and zirconia crystalline phases, furthermore, the second crystalline phase can also includes a mullite crystalline phase.

### CROSS REFERENCE TO RELATED APPLICATIONS

This Application claims priority of Taiwan Patent Application No. 098123688, filed on Jul. 14, 2009, the entirety of which is incorporated by reference herein.

### BACKGROUND OF THE INVENTION

1. Field of the Invention

The invention relates to an optoelectronic device substrate, and more particularly to an optoelectronic device substrate utilized in high temperature environments.

2. Description of the Related Art

Forming a non-insulating film is required when fabricating optoelectronic devices on a substrate such as semiconductors, microelectromechanical systems, light emitting diodes, solar cells or thin film transistors. Currently, the non-insulating film is formed on a common glass substrate by using physical vapor deposition or chemical vapor deposition with process temperature lower than 500° C. due to limited in heat resistance of the glass substrate. However, an amorphous non-insulating film is formed under lower processes temperature and the higher process temperature will produce crystalline film with regular arrangement, which has higher electron mobility and lower temperature sensitivity than the amorphous film, facilitating better performance of optoelectronic devices fabricated therefrom, furthermore higher process temperature can also increase the throughput of production.

Silicon is one of the non-insulating films, laser annealing or laser recrystallization process is used to transfer an amorphous silicon film to a polysilicon film under a low process temperature. The temperature of the substrate is maintained at 400° C. The amorphous silicon film is sequentially and locally melted then recrystallized by laser irradiation. However, the process cannot form a uniform crystallinity silicon film.

In order to form a uniform crystallinity silicon film, high temperature exceeding 600° C. is required for the aforementioned process. However, if the coefficient of thermal expansion of the substrate is apparently different from the silicon film, thermal stress is easily generated therebetween, resulting in deformation, warping or peeling off in the silicon film and substrate structure.

### BRIEF SUMMARY OF THE INVENTION

An optoelectronic device substrate having similar coefficient of thermal expansion with non-insulating materials, particularly silicon, is provided.

Embodiments of the invention provide: a ceramic powder composition comprising zircon of 4-97 wt % and at least one of silicon dioxide less than 60 wt % and alumina less than 80 wt %, or a ceramic powder composition comprising zircon of 43-97 wt %, and at least one of silicon dioxide less than 34 wt % and alumina less than 57 wt % for the best results; a ceramic powder composition comprising zircon of 4-85 wt %, silicon dioxide of 4-60 wt % and alumina of 10-80 wt %; or a ceramic powder composition comprising zircon of 5-79 wt %, silicon dioxide of 4-55 wt % and alumina of 6-69 wt % for the best results.

Embodiments of the disclosed ceramic powder compositions further comprises: a first oxide less than or equal to 20 wt % selected from the group consisting of magnesium oxide, calcium oxide, strontium oxide, barium oxide, boron oxide and phosphorus pentoxide or glass, the composition of glass comprising silicon dioxide, alumina, magnesium oxide, calcium oxide, strontium oxide, barium oxide, boron oxide, phosphorus pentoxide and so on, that with glass phase observed by X-ray diffrationmeter; or a second oxide less than 5 wt % selected from the group consisting of lithium oxide, sodium oxide, potassium oxide, lead oxide and ferric oxide.

An optoelectronic device substrate formed by sintering one of the disclosed ceramic powder compositions is provided.

Embodiments of the optoelectronic device substrate comprising a first crystalline phase of zircon, a second crystalline phase selected from the group consisting of mullite, silicon dioxide, alumina, zirconium oxide, and the glass phase. When the second crystalline phase with or without mullite, the ceramic powder composition can only comprise at least one of silicon dioxide and alumina

Embodiments of the optoelectronic device substrate have a coefficient of thermal expansion of 2-7×10⁻⁶/° C. at a temperature range between room temperature to 900° C.; a roughness average (Ra) less than or equal to 500 nm and a warpage less than or equal to 0.5%. The Ra has been defined as the mathematics formula:

$$Ra = \frac{( h 1 + h 2 + h 3 + … hn ) \cdot Δ x}{L} = \frac{\sum f ( x ) dx}{L} ,$$

where the L is the measurement length and segment the length to n section with the same distance x, h1 is the height at position 1, h2 is the height at position 2 and deduced by analogy to hn. The warpage is the quantification of shape deformed and has been defined as the mathematics formula:

$$\% = \frac{T 1 - T 0}{L} \times 100 \%$$

where L is the length of the substrate, T1 is the thickness of the sintered substrate and T0 is the thickness of origin substrate.

Embodiments of the optoelectronic device substrate further comprise: a non-insulating film deposited on the substrate, wherein the non-insulating film have a coefficient of thermal expansion of 1-8×10⁻⁶/° C. at a temperature range between room temperature to 900° C. similar to the substrate; the non-insulating film material are selected from the group consisting of Si, Ge, SiGe, InGaN, GaN, GaAs, CIGS (Cu—In—Ga—Se system with different composite ratio), ITO, AZO and GZO.

Embodiments of the optoelectronic device substrate are applied in solar cells, light-emitting diodes, thin film transistors or microelectromechanical systems.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawing, wherein:

FIG. 1 is a cross-sectional view of a ceramic substrate with a non-insulating film according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

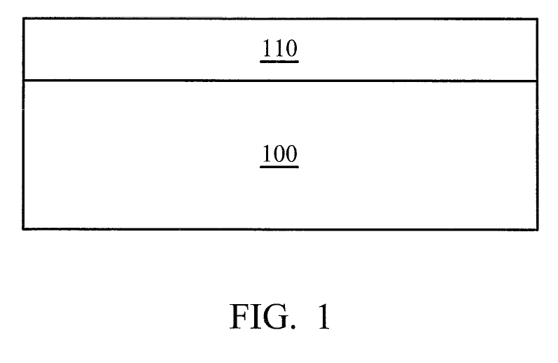

A ceramic powder composition comprising zircon, silicon dioxide and alumina are sintered with a temperature exceeding 1200° C. to form a ceramic substrate 100 (refer to FIG. 1). The ceramic substrate 100 may have a similar coefficient of thermal expansion to silicon (2.6×10⁻⁶/° C.) or other non-insulating film. The coefficient of thermal expansion of the ceramic substrate 100 may be altered by adjusting the compositions of zircon, silicon dioxide and alumina. For example, when a ceramic powder composition comprising 4 to 97 wt % of zircon, 0 to 60 wt % of silicon dioxide and 0 to 80 wt % of alumina (that is, contain at least one of silicon dioxide less than 60 wt % and alumina less than 80 wt %) is provided, by using this composition the ceramic substrate will with or without the second crystalline phase mullite. More preferably, a ceramic powder composition comprising 43 to 97 wt % of zircon, 0 to 34 wt % of silicon dioxide, and 0 to 57 wt % of alumina is provided. The coefficient of thermal expansion (especially at a temperature ranging from room temperature to 900° C.) of the ceramic substrate 100 may be altered from 2 to 7×10⁻⁶/° C.

Preferably, a ceramic powder composition comprising 4 to 85 wt % of zircon, 4 to 60 wt % of silicon dioxide, and 10 to 80 wt % of alumina is provided, by using this composition the ceramic substrate will with the second crystalline phase mullite. More preferably, a ceramic powder composition comprising 5 to 79 wt % of zircon, 4 to 55 wt % of silicon dioxide, and 6 to 69 wt % of alumina is provided.

The ceramic substrate 100 shown in FIG. 1 may have a similar coefficient of thermal expansion with non-insulating materials. The non-insulating film may be semiconductors or conductors, and material thereof may be selected from the group consisting of Si, Ge, SiGe, InGaN, GaN, GaAs, CIGS (Cu—In—Ga—Se system with different composite ratio), ITO, AZO and GZO.

The non-insulating film 110 composed of the disclosed the non-insulating materials is formed on the ceramic substrate 100 in the lower process temperature, then annealed in the higher temperature exceeding 600° C. or directly deposited on the ceramic substrate 100 in the higher temperature by vapor deposition, liquid phase epitaxy, solid phase epitaxy, thermal evaporation, printing or plating. Thus, a crystalline non-insulating film with uniform crystallinity and high adhesion strength may be obtained. The crystalline non-insulating film is not deformed, warped, peel off or crack. In accordance with the thickness of the non-insulating film 110, the Ra of the ceramic substrate 100 may be adjusted by mechanical processes or adding buffer layers. In embodiments of the invention, the ceramic substrate 100 with a non-insulating film 110 may be applied in solar cells, light-emitting diodes, thin film transistors or microelectromechanical systems.

In one embodiment, preferably, the ceramic substrate 100 has a surface roughness less than or equal to 500 nm, similar to a conventional alumina substrate, thereby reducing the thickness variation of the non-insulating film 110 and improving production yield and performance of devices made therefrom. In one embodiment, the ceramic substrate 100 has a preferable sintered density/theoretical density percentage of 85% or above, the higher percentage means the lower porosity of the ceramic substrate that dense enough to undergo the further process, such as to reduce the surface roughness of the ceramic substrate 100 can reduce the variation of the non-insulating film 110 thickness which will improve the production yield and devices performance make therefrom. In one embodiment, the ceramic substrate 100 has a preferable warpage less than or equal to 0.5%, thereby improve the production yield and facilitate modulization.

The disclosed ceramic powder composition may further comprise a proper amount of a sintering aid (first oxide), preferably less than or equal to 20 wt %. The sintering aid may be selected from the group consisting of magnesium oxide, calcium oxide, strontium oxide, barium oxide, boron oxide, and phosphorus pentoxide and glass. The sintering aid will reduce the sintering temperature, deteriorating the heat resistance (the ability of anti-deformation and anti-warping) and change the coefficient of thermal expansion of the ceramic substrate at the same time. Thus, the amount of the sintering aid of the ceramic powder composition is preferably less than or equal to 20 wt % to ensure the glass phase is less than 20 wt %.

Meanwhile, a second oxide may be selected from the group consisting of lithium oxide, sodium oxide, potassium oxide, lead oxide and ferric oxide. They have the similar function to sintering aid (first oxide), but easily diffused into the non-insulating film 110 during the high process temperature, deteriorating the quality of the non-insulating film 110 and performance of the device. Thus, we won't extraneous add, the amount of the second oxide of the ceramic powder composition is preferably less than 5 wt % may originate in other raw material and glass.

The ceramic substrate 100 (refer to FIG. 1) formed by sintering a ceramic powder composition with a temperature exceeding 1200° C. has a first crystalline phase and a second crystalline phase. The first crystalline phase is zircon. The second crystalline phase may be selected from the group consisting of mullite, silicon dioxide, alumina and zirconium oxide. Preferably, the ceramic powder composition comprises 4 to 97 wt % of zircon, 0 to 60 wt % of silicon dioxide and 0 to 80 wt % of alumina (that is, contain at least one of silicon dioxide less than 60 wt % and alumina less than 80 wt %) that the ceramic substrate with or without the second crystalline phase mullite. More preferably, the ceramic powder composition comprises 43 to 97 wt % of zircon, 0 to 34 wt % of silicon dioxide, and 0 to 57 wt % of alumina. Preferably, the ceramic powder composition comprises 4 to 85 wt % of zircon, 4 to 60 wt % of silicon dioxide, and 10 to 80 wt % of alumina that the ceramic substrate with the second crystalline phase mullite. More preferably, the ceramic powder composition comprises 5 to 79 wt % of zircon, 4 to 55 wt % of silicon dioxide, and 6 to 69 wt % of alumina. The crystalline phase of the ceramic substrate 100 formed by sintering a ceramic powder composition with a temperature exceeding 1200° C. may further comprise a first crystalline phase of zircon, a second crystalline phase selected from the group consisting of mullite, silicon dioxide, alumina and zirconium oxide.

It is very difficult to sinter completed of each single phase, zircon, mullite, alumina, silicon dioxide and zirconium oxide, all these single phase substrate have the disadvantages in use. There are low stability and mechanical strength in zircon substrate, higher coefficient of thermal expansion and cost a lot in zirconium oxide substrate, alumina substrate still have the the problem of higher coefficient of thermal expansion that limit their applications. The mullite substrate is produced by reaction between alumina and silicon dioxide under a temperature exceeding 1200° C., the zirconium oxide crystalline phase is produced by decomposition of zircon during the sintering process, and the degree of decomposition of zircon depend on the process temperature. The ceramic substrate 100 having the first crystalline phase and the second crystalline phase, or oxide contain, improves the previously mentioned shortcomings and is lower in cost, using a low sintering temperature (lower than or equal to 1700° C.). Additionally, the ceramic substrate 100 has a sintering density/theoretical density percentage of 85% or above, resulting in less pores over the interior and surface thereof. Thus, a ceramic substrate with high quality, low surface roughness and high mechanical strength is obtained. Compared to the ceramic substrate composed of a single alumina or mullite phase, the ceramic substrate 100 has smaller Ra after the same chemical mechanical polishing process. In one embodiment, the ceramic substrate 100 is magnesium crystalline phase free. In one embodiment, the ceramic substrate 100 comprises a glass phase containing magnesium oxide, but still is magnesium oxide crystalline phase free.

### Examples

Various ceramic powder compositions were respectively sintered into various ceramic substrates (Examples 1-25) and the physical properties of the sintered ceramic substrates were determined, and are shown in Table 1.

TABLE 1

| | | | | | The physical properties of the | | |
|---|---|---|---|---|---|---|---|
| | | | | | sintered ceramic substrates | | |
| | | | | | CTE | | |
| | Ceramic powder compositions | | | | (Room | | |
| | | Silicon | | Sintering | temperature | | |
| | Zircon | dioxide | Alumina | aid | to 900° C.) | Crystalline | Density |
| Examples | wt % | wt % | wt % | wt % | 10⁻⁶/° C. | phase | g/cm³ |
| 1 | 5 | 26 | 69 | 0 | 4.4 | Z, M, A | 2.9 |
| 2 | 5 | 28 | 67 | 0 | 3.7 | Z, M, S | 2.8 |
| 3 | 6 | 26 | 68 | 0 | 4.2 | Z, M | 2.9 |
| 4 | 15 | 18 | 58 | 9 | 4.4 | Z, M, A | 3.0 |
| 5 | 14 | 16 | 52 | 18 | 4.8 | Z, M, A | 2.8 |
| 6 | 17 | 19 | 64 | 0 | 5.5 | Z, M, A | 3.2 |
| 7 | 17 | 55 | 28 | 0 | 2.0 | Z, M, S | 2.6 |
| 8 | 25 | 20 | 55 | 0 | 5.0 | Z, M, A, S | 2.9 |
| 9 | 27 | 20 | 44 | 9 | 3.9 | Z, M, S | 2.9 |
| 10 | 27 | 18 | 55 | 0 | 5.1 | Z, M, A | 3.3 |
| 11 | 27 | 18 | 47 | 9 | 4.4 | Z, M | 2.9 |
| 12 | 28 | 21 | 51 | 0 | 4.8 | Z, M, A, S | 3.3 |
| 13 | 29 | 22 | 49 | 0 | 3.7 | Z, M, S | 3.2 |
| 14 | 30 | 20 | 50 | 0 | 4.1 | Z, M | 3.3 |
| 15 | 37 | 16 | 47 | 0 | 4.8 | Z, M, A | 3.4 |
| 16 | 43 | 11 | 37 | 9 | 5.1 | Z, M, A | 3.2 |
| 17 | 39 | 10 | 33 | 18 | 5.4 | Z, M, A | 2.9 |
| 18 | 47 | 12 | 41 | 0 | 5.0 | Z, M, A | 3.4 |
| 19 | 64 | 0 | 36 | 0 | 6.1 | Z, A | 3.6 |
| 20 | 74 | 6 | 20 | 0 | 4.6 | Z, M, A | 3.7 |
| 21 | 75 | 9 | 16 | 0 | 3.8 | Z, M, S | 3.8 |
| 22 | 75 | 25 | 0 | 0 | 2.4 | Z, S | 3.5 |
| 23 | 79 | 6 | 15 | 0 | 4.2 | Z, M | 3.7 |
| 24 | 94 | 0 | 6 | 0 | 4.6 | Z, A | 3.8 |
| 25 | 96 | 4 | 0 | 0 | 3.8 | Z, S | 4.2 |

*The sintering aid is first oxide selected from the group consisting of magnesium oxide, calcium oxide, strontium oxide, barium oxide, boron oxide, and phosphorus pentoxide.
**Z represents a zircon crystalline phase, M represents a mullite crystalline phase, A represents an alumina crystalline phase and S represents a silicon dioxide crystalline phase or amorphous phase.
*** The zirconium oxide crystalline phase is omitted in Table 1.

The fabrication process of the disclosed ceramic substrates comprises preparation, shaping and sintering of the ceramic powder compositions.

First, in accordance with the ceramic powder compositions recited in Table 1, zircon powder, silicon dioxide powder and alumina powder with a proper amount were wet-mixed and ball mill for two hours. The mixture was dried under 100° C. The dried mixture was then shaped and sintered under the air atmosphere below 1700° C. to form a ceramic substrate. In one embodiment, adding the sintering aid, for example magnesium oxide, calcium oxide, strontium oxide, barium oxide, boron oxide, and phosphorus pentoxide, is described as follows. First, in accordance with the ceramic powder compositions recited in Table 1, zircon powder, silicon dioxide powder, alumina powder and sintering aid with a proper amount were wet-mixed and ball mill for two hours. The mixture was dried under 100° C. The dried mixture was then shaped and sintered under the air atmosphere below 1400° C. to form a ceramic substrate.

The coefficient of thermal expansion, crystalline phase and sintering density of the ceramic substrates were then determined. The coefficient of thermal expansion of the substrate was observed by the thermomechanical analyzer (TMA), the crystallinity of the ceramic substrates was observed by X-ray diffrationmeter (XRD).

The results indicated that the coefficient of thermal expansion (from room temperature to 900° C.) of the sintered ceramic substrates was ranging between 2-7×10⁻⁶/° C., similar to the non-insulating film 110 (for example of silicon film). If an amorphous silicon film is formed on the ceramic substrate, the film may be annealed in a high temperature exceeding 600° C. to get a polysilicon film or the polysilicon film may be directly deposited on the ceramic substrate in a high temperature, without deformation, warping, peeling or cracking of the silicon film and ceramic substrate structure.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A ceramic powder composition, comprising:
zircon of 4-97 wt %; and
at least one of silicon dioxide less than 60 wt % and alumina less than 80 wt %.

2. The ceramic powder composition as claimed in claim 1, further comprising a first oxide less than or equal to 20 wt % selected from the group consisting of magnesium oxide, calcium oxide, strontium oxide, barium oxide, boron oxide, phosphorus pentoxide and glass.

3. An optoelectronic device substrate formed by sintering a ceramic powder composition as claimed in claim 1

4. The optoelectronic device substrate as claimed in claim 3, wherein the substrate has a first crystal phase of zircon and a second crystal phase selected from the group consisting of silicon dioxide, alumina and zirconium oxide.

5. The optoelectronic device substrate as claimed in claim 3, wherein the substrate has a coefficient of thermal expansion of 2-7×10⁻⁶/° C. at a temperature ranging from room temperature to 900° C.

6. The optoelectronic device substrate as claimed in claim 3, further comprising a non-insulating film deposited on the substrate, wherein the non-insulating film has a coefficient of thermal expansion of 1-8×10⁻⁶/° C. at a temperature ranging from room temperature to 900° C.

7. The optoelectronic device substrate as claimed in claim 4, wherein the second crystalline phase further comprises a mullite crystalline phase.

8. The optoelectronic device substrate as claimed in claim 4, wherein the substrate comprises a glass phase.

9. The ceramic powder composition as claimed in claim 1, wherein zircon is 43-97 wt %, silicon dioxide is less than 34 wt % and alumina is less than 57 wt %.

10. The ceramic powder composition as claimed in claim 1, wherein zircon is 4-85 wt %, silicon dioxide is 4-60 wt % and alumina is 10-80 wt %.

11. The ceramic powder composition as claimed in claim 1, wherein zircon is 5-79 wt %, silicon dioxide is 4-55 wt % and alumina is 6-69 wt %.

12. The optoelectronic device substrate as claimed in claim 3, wherein the substrate is applied in solar cells, light-emitting diodes, thin film transistors or microelectromechanical systems.

13. The optoelectronic device substrate as claimed in claim 6, wherein the non-insulating film is selected from the group consisting of Si, Ge, SiGe, InGaN, GaN, GaAs, CuInGaSe (CIGS), ITO, AZO and GZO.

14. The optoelectronic device substrate as claimed in claim 3, wherein the substrate has a surface roughness less than or equal to 500 nm.

15. The optoelectronic device substrate as claimed in claim 3, wherein the substrate has a warpage less than or equal to 0.5%.
